(19) United States
(12) Patent Application Publication
(10) Pub. No.: US 2005/0169248 A1
(43) Pub. Date: Aug. 4, 2005

(54) Method and apparatus for providing in-band location information in an emergency response network

(75) Inventors: Larry Truesdale, Allen, TX (US); Jeanine McDermott, Murphy, TX (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/771,607

(22) Filed: Feb. 4, 2004

(51) Int. Cl. H04L 12/66

(52) U.S. Cl. 370/352; 370/395.52

(57) ABSTRACT

Location information associated with an access device on a data network may be generated by the network and transmitted in-band on an emergency call to a PSAP to allow the PSAP operator to obtain the location of the caller for emergency services. The location information may be audible or may be generated in a form readable by a machine at the PSAP operator's station. The information may be provided automatically or on-demand. Enabling the data network to generate and transmit the location information enables the data network to provide more up-to-date location information than if the location information were required to be updated into the PSAP's ALI database. Additionally, mobility on the data network may be accommodated to enable the emergency location service to be provided on a wireless network. A database associated with the service may be configured to store the location information, which may then be provided in connection with emergency calls.

### BACKGROUND OF THE INVENTION

1. Field of the Invention

The present invention relates to delivery of location information in a communication network and, more particularly, to a method and apparatus for providing in-band location information in an emergency response network.

2. Description of the Related Art

Public emergency response services have been developed to enable citizens to contact emergency personnel in the event of an emergency. Such services are commonly used to summon police, fire, and ambulance services, although other emergency response teams may be summoned through the emergency services as well. Conventionally, a Public Safety Answering Point (PSAP) is established and made available to the public through a special dedicated telephone number. In the United States, it is common to use “911” to reach a local PSAP, although other numbers may be used to reach the PSAP in other jurisdictions. For example, in Australia, emergency services may be accessed by dialing “000,” while in several countries in Europe emergency services may be accessed by dialing “112,” “061,” “080,” “091,” “100,” or “101.” Thus a variety of numbers may be used to obtain access to the emergency response network.

When a person dials into an emergency response network by dialing 911 or another access number, it is important for the operator to be able to identify the location of the person making the phone call so that emergency personnel and equipment may be dispatched to the correct location. One way of doing this with traditional telephony equipment is through an Enhanced 911 (E911) service. E911 is an emergency telephone system capable of automatically displaying the callback number and in some cases the location of the person that dialed the emergency access number.

The North American emergency E911 phone system in many areas includes a voice network that is built largely outside of the normal Public Switched Telephone Network (PSTN) on which common voice traffic resides. Calls to emergency services are treated with higher importance and are routed differently from normal traffic within the PSTN. Essentially, calls to emergency services are routed on the basis of the calling number, not the called number. The calling number is checked against a database of emergency service providers that cross-reference the service providers for the caller's particular location. When this information is determined, the call is then routed to the proper Public Safety Answering Point (PSAP) which then dispatches services to the caller's location.

In most E911 networks, the calling number and called number are transmitted in-band. This in-band signaling allows the calling number to be used to reference an Automatic Location Identification (ALI) database to find the caller's exact location and any other information about the caller that may have been stored in the database. It also provides the operator with a callback number in case the call is disconnected. However, the existing installed ALI systems were not designed to operate in an environment where telephony handsets are moving rapidly from location to location. Indeed, in many such systems it may take up to 24 hours to update a change in location in the ALI information database.

Cellular operators have developed another system so that the location of the cellular handset may be ascertained when a cellular handset is used to place a call to the PSAP. In the cellular context, there are various ways of ascertaining the location of a handset. Examples include using Global Positioning System (GPS) signals embedded in the transmission signal or using triangulation by looking to see which of the several Base Transceiver Stations (BTSs) in the neighborhood of the cellular handset are able to transmit/receive information from the cellular handset and, using direction and strength information, ascertaining a likely location of the handset.

A third type of telephony has recently been developed, which allows voice to be transmitted over a data communication network. Data communication networks may include various nodes, hubs, routers, switches, and other devices coupled to and configured to pass data to one another. These devices will be referred to herein as “network elements.” Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network.

Communicating voice over a data network is advantageous in that many enterprise customers and metropolitan areas have deployed data networks. In particular, one protocol referred to herein as Internet Protocol (IP) is used extensively on data networks to enable communications to take place on the data network. Where voice is to be implemented on an IP network, it has become common in the industry to refer to the communication as “Voice over IP” (VoIP).

Enabling voice traffic to be carried on a data network raises concerns with respect to the provision of emergency services. Specifically, since IP enabled handsets may connect to the network at any number of different points, it becomes difficult to ascertain the location of the person placing the emergency call to the PSAP. For example, a given IP telephone handset may be attached to the network in any number of places. Additionally, where the IP network is supported by a wireless access network, such as an 802.11x wireless access network, the location of the telephone on the network may change even more rapidly. Attempting to update these changes in the ALI database associated with the PSAP is simply not feasible, given the time it takes to update a change in the existing installed ALI databases.

One system has been proposed in which an Emergency Location ID Number (ELIN) is associated with each physical port on the network and uploaded to the ALI associated with the local PSAP. A database keeps track of IP handsets on the network and, upon receipt of an emergency call, associates an ELIN with the call and transmits the ELIN to the PSAP. The PSAP then uses the ELIN to key into the PSAP ALI database. Unfortunately, this solution presents a proprietary approach that will only work where the location information is able to be loaded into the ALI database. Moreover, since the ELIN information is static, this proposal does not support location of IP handsets in a wireless data network such as an 802.11x network. Accordingly, it would be advantageous to provide a method and apparatus for providing location information in connection with the rendition of emergency services without requiring extensive uploading of network information to the PSAP ALI database and without requiring new infrastructure to be deployed in the public network.

### SUMMARY OF THE INVENTION

The present invention overcomes these and other drawbacks by providing a method and apparatus for providing in-band location information in an emergency response network. According to an embodiment of the invention, location information associated with the location of the access device being used to engage in the emergency communication session is carried in-band to the PSAP to enable the PSAP operator to hear or retrieve the location information directly from the call. By including the location information in-band, the reliable voice stream may be used to implement location detection to enable the person placing the emergency call to be located in the event the person is not able to properly identify their present location. Additionally, by enabling the voice stream to carry the location information, the operator at the PSAP may be provided with information about the person's location without requiring the installation of any particular equipment at the PSAP and without requiring modification of the existing set of installed ALI databases.

Different embodiments of the invention may implement the invention in different forms. For example, the location information may be transmitted over the voice channel to the PSAP as audible data and played out to the operator as audible information. Alternatively or additionally, the location information may be transmitted over the voice channel as a data stream that is able to be interpreted by the PSAP or an electronic device in the PSAP so that the location information may be displayed automatically or on demand by the operator. Optionally, where the location information is not audible, the location information may be formatted to mimic a conventional standard such to make the data appear, e.g., as if it were being generated from an ALI database.

The location information may be provided automatically when the call is established, or at another point during the emergency communication session. Alternatively, the location information may be provided on demand, for example by enabling the PSAP operator to request the location information by depressing a sequence of keys. The invention is not limited to when the in-band location information is provided in connection with the emergency communication session.

The location information may take on numerous different forms. For example, the location information may contain civic information such as the address of the access device being used to place the emergency call, or may contain geodetic information such as the longitude, latitude, and altitude of the person placing the emergency call. Other types of information may be provided as well and the invention is not limited to these several examples.

The location information may be stored in the access device, may be stored in a network element implementing the voice functionality and configured to enable the access device to engage in voice communication sessions on the data network, or in a number of different settings. A network element that is configured to enable voice communication sessions on the IP network may encompass numerous different types of network elements, such as a private branch exchange (PBX), soft switch, or any other similar type of network element.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a communication network configured to implement an embodiment of the invention;

FIG. 2 is a functional block diagram of the communication network of FIG. 1 in greater detail in which wired connections are used to connect access devices to the data network according to an embodiment of the invention;

FIG. 3 is a functional block diagram of the communication network of FIG. 1 in greater detail in which wireless connections are used to connect wireless access devices to the data network according to an embodiment of the invention;

FIG. 4 is a functional block diagram of one of the communication networks of FIGS. 1-3 in greater detail of the access device; and

FIGS. 5 and 6 are functional block diagrams of embodiments of the call server and E-911 server of FIG. 4 in greater detail.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

According to an embodiment of the invention, location information is included in the voice stream of an emergency call (in-band) when the emergency call is made from a packet based or other data network. Including the location information in the voice stream enables an operator at a legacy Public Safety Answering Point (PSAP) to determine the location of the caller without requiring updates to occur in the Automatic Location Identification (ALI) database. As discussed below, the location information may be provided automatically or, optionally, on demand such as in response to the depression of one or more telephone keys by the PSAP operator. Additionally, the data may take many different forms depending on the particular implementation.

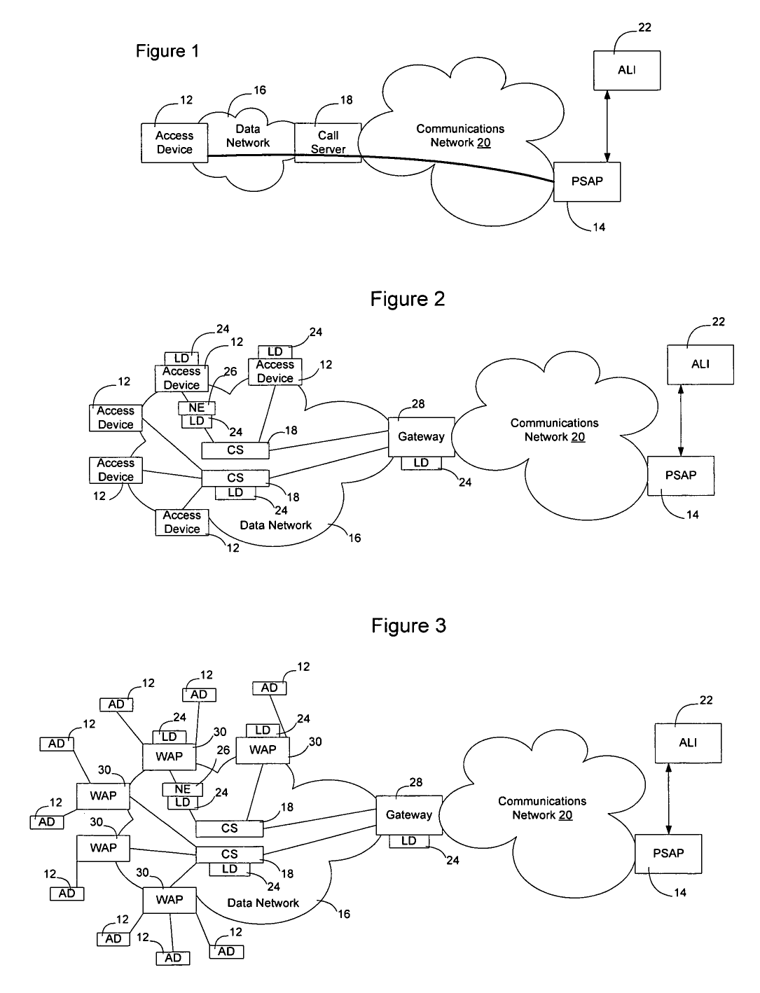

FIG. 1 illustrates a communication network 10 in which an access device 12 is used to place an emergency call to a PSAP 14. As shown in FIG. 1, the access device 12 may obtain access to the PSAP 14 by issuing a command on the data network, such as an IP network or other packet-based network, to which it is attached 16. The data network 16 conveys the call information to a Call Server 18 which converts the signaling used on the data network to a format in use on the communication network 20, so that the call can be passed over the communication network 20. The communication network may be a public network such as the Public Switched Telephone Network (PSTN), the Internet, or other communication network. The call server may be a conventional call server, Private Branch Exchange (PBX), gateway, or other network element configured to handle voice communication sessions on behalf of the data network 16. While embodiments of the invention will be described below as pertaining to “911” service, the invention is not limited in this regard as it may be extended to other numerical access codes as well.

Once the call reaches the communication network 20, the call is handled like a regular emergency call according to the procedures established on that portion of the network. For example, optionally, where E-911 services are installed, an Automatic Location Identification (ALI) database 22 may be included to provide additional information associated with the emergency call to the PSAP operator. While the invention will be described in connection with providing location information in an emergency response network such as the emergency response network illustrated in FIG. 1, other emergency infrastructures may be deployed as well and the invention is not limited to use in connection with this particular emergency infrastructure.

FIGS. 2 and 3 illustrate several examples of the network of FIG. 1 in greater detail, in which FIG. 2 illustrates a wireline data network while FIG. 3 illustrates a wireless data network. The two networks may be combined to include a partially wireline and partially wireless network as well. In the wireline context, as shown in FIG. 2, location data 24 to be provided on the emergency call may be provided or stored in many areas on the network. For example, in the embodiment illustrated in FIG. 3, the location data may be provided by or stored on the PBX or call server 18, on a network element 26 such as a router deployed on the network, on the access devices 12 that are connected to the packet network, or at a gateway 28 between the network and the communication network 20. Similarly, in the wireless embodiment illustrated in FIG. 3, the location data 24 may be provided by or stored on the wireless access devices 12, on a wireless access point 30, on a network element such as a router 26, on the PBX or call server 18, or on the gateway 28. Optionally, different portions of the location data 24 may be stored or provided by different components of the network in several locations on the network and the invention is not limited to an embodiment that includes all the location data for a given user in one place on the network. The invention is thus not limited to where the location data is stored on the network.

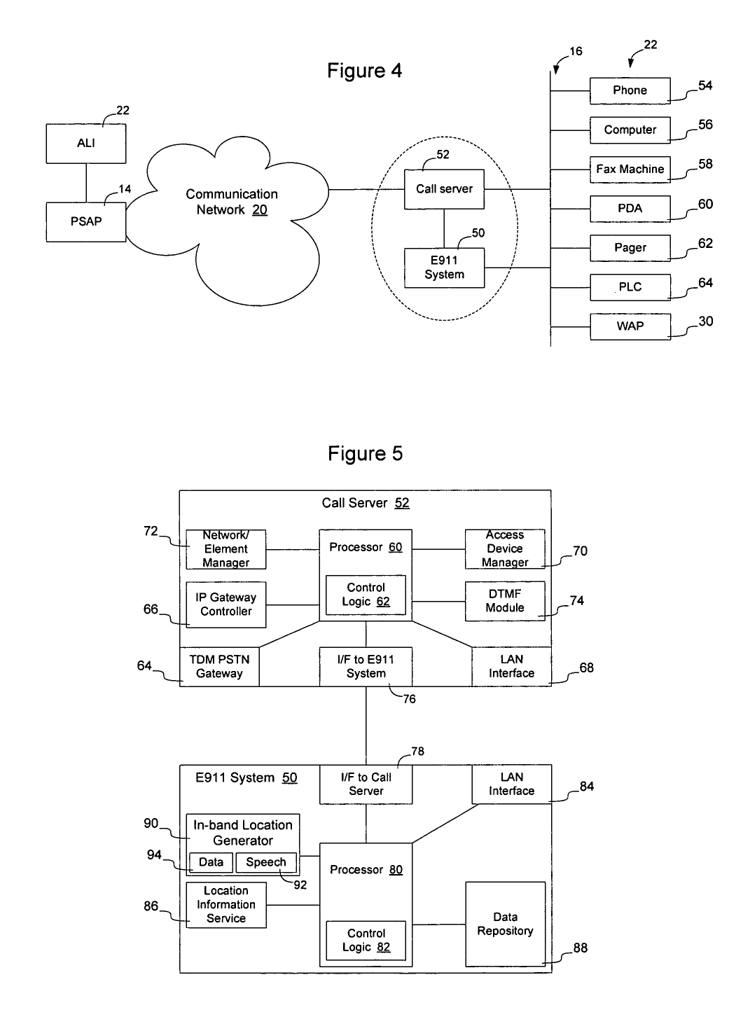

FIG. 4 illustrates an embodiment of the invention in which an E-911 system 50 is deployed on a data network and interfaced with a call server 52 to enable location information services to be provided to access devices 12 communicating on the network 16. The call server 52 may take the form of the call server 18 illustrated in FIGS. 1-3 or may be another network element on the data network. The call server 52 may be implemented in a gateway, e.g. on the edge of the network, on another network element within the data network 16, or as a stand-alone network element. The invention is not limited to the embodiment illustrated in FIG. 4 as many implementations may be possible.

Additionally, although emergency services have traditionally been provided in response to emergency calls generated by devices such as a telephone handset 54, the invention is not limited in this manner. Rather, as shown in FIG. 4, emergency access may be provided to a user from any access device on the data network 16. Examples of such access devices may include a computer 56, a fax machine 58, a Personal Data Assistant (PDA) 60, a pager 62, or a Programmable Logic Controller (PLC) 64 (used to control devices in an industrial network) or via wireless access point 30. One or more of these devices may be configured to communicate on an emergency communication session using instant messaging, e-mail or another form of text-based messaging, voice messaging, or multi-media communications. Other access devices may be used as well, and the invention is not limited to obtaining emergency services over an emergency communication session using one of these several illustrated access devices.

FIG. 5 illustrates the E-911 system 50 and call server 52 of FIG. 4 in greater detail. The call server and E-911 system may be deployed on separate platforms within either the same or different networks, or on the same platform. As discussed above, the invention is not limited to the manner in which the components, such as the call server and E-911 system of FIG. 5 are deployed on the network. For example, in FIG. 5, the call server is implemented in a network element configured to perform as a gateway on the data network. The invention is not limited in this manner; however it may be convenient to include the call server with the gateway for conservation of resources on the network. Other embodiments may separate the functionality of these components without departing from the invention disclosed herein.

In the embodiment illustrated in FIG. 5, the call server/gateway includes a processor 60 having control logic 62 configured to enable the call server/gateway to perform functions ascribed to it herein. For example, the call server may be configured to establish calls on the data network while the gateway may be configured to interface those calls to external resources on the communication network 20. The processor and control logic enable software and dedicated hardware to interoperate to implement these functions.

The call server may include one or more modules to enable it to handle aspects of the telephony associated with accessing the communication network, establishing a session on the LAN to support the communication session, or other aspects associated with enabling calls or other sessions to be set up, established, terminated, and managed on the LAN/external communication network. For example, in the embodiment illustrated in FIG. 5, a Time Division Multiplex (TDM) PSTN gateway 64 is provided to interface the call server/gateway to T1 lines, such as Primary Rate Interface (PRI) or Centralized Automated Message Accounting (CAMA) trunks connected to the PSTN. The invention is not limited in this regard, however, as other trunks or links may be used to connect the call server to other networks. For example, an IP Gateway Controller 66 is provided to control operations within the IP network. For example, a data network (LAN) interface 68 enables the call server/gateway to be connected to the local area network (data network 16) to enable the call server/gateway to provide telephony services to access device(s) 12 connected to the data network 16. Additionally, for example, the call server may include an Access Device Manager 70 to manage IP telephony connections on the LAN. Also, a Network/Element Manager 72 may be included to enable operations, maintenance, administration, billing, performance surveillance, data control, and network management to take place for the call server. Other components may be included as well, and the invention is not limited to these particular interfaces or functionality. These components are conventionally included in a gateway or call server and are well known to persons of ordinary skill in the art.

Optionally, the call server may include a Dual-Tone MultiFrequency (DTMF) module 74 configured to receive inputs from the PSAP operator to enable the operator to control how and/or when the location information is transmitted. Other embodiments may use other mechanisms to enable the PSAP operator to control the delivery of the location information and the invention is not limited to use of a DTMF module and the generation of DTMF signals.

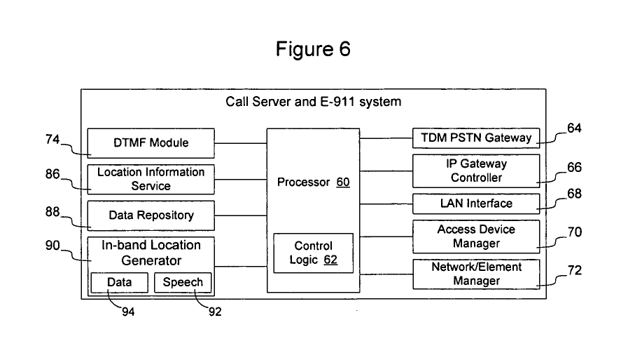

The E-911 system 50, like the call server 52, may include a processor 80 containing control logic 82 configured to implement the functions attributed to it and described herein. Where the call server and E-911 system are collocated on one platform, such as the embodiment illustrated in FIG. 6, the two systems may share a common processor and control logic.

As illustrated in FIG. 5, the two systems may be physically located on separate systems and may be configured to communicate with each other. This may take place over the LAN interfaces 68, 84 or, optionally as illustrated, via dedicated interfaces 76, 78 on the call server and E-911 system The invention is not limited to how the two systems are interfaced with each other. Optionally, where the two systems are implemented as illustrated in FIG. 5, Extensible Markup Language (XML) or Simple Object Access Protocol (SOAP) may be used to pass information between the call server and E-911 system. The invention is not limited to the use of these particular protocols, however.

The E-911 system according to an embodiment of the invention includes several components. For example, as illustrated in FIG. 5, the E-911 system may include a Location Information Service (LIS) 86 which, in this embodiment, implements a device discovery system. Location discovery may be done via Simple Network Management Protocol (SNMP), Session Initiation Protocol (SIP), 802.1x, Dynamic Host Control Protocol (DHCP) or another common network management protocol. For example, according to one embodiment of the invention, SNMP-enabled layer 2 switches are used to query network devices as to the location of access devices connected on the network. SNMP provides a standard, currently available, solution for locating devices. Data collected by the LIS is stored in a data repository 88 to enable network address information to be correlated to a specific physical location.

In operation, when an access device becomes active on the network or moves from one location to another location on the network, the access device is registered with the E-911 system 50. This registration may provide the IP address, Media Access Control (MAC) address, wireless access point, or other data relating to the location of the access device 12 on the network or in physical space. This information is stored in the data repository 88.

Once the E-911 system control logic 82 has sufficient location information, such as the IP address and/or MAC address of the access device or otherwise becomes aware of the access device, any correlation calculations, such as wireless access point triangulation information, may be performed and stored along with the other registration and identification information in the data repository 88. The information in the data repository may be updated periodically, by listening to routing updates on the network or otherwise by setting SNMP or other traps on the network. The invention is not limited to the manner in which data is collected, stored, or updated in the data repository 88.

Optionally the data repository 88 may be configured to store information derive from the information collected from the network. For example, the data repository may be configured to store pre-recorded location information to be played back over the emergency communication session. Thus, the data repository may store multiple types of information if desired, and the invention is not limited to one particular type of data.

When an emergency call is placed, the call is directed to the call server that completes the emergency call in a standard fashion with the PSAP. In connection with the emergency call, the call server may access the E-911 system to determine the location of the caller, so that it knows which PSAP should receive the call. For example, the caller may be calling from a port on the network within a facility that has its own emergency response team. In that event, the emergency call should be routed to the local emergency response personnel. Alternatively, the caller may be calling from a remote site or from a residence, in which case routing the call to the facility's dedicated emergency response team would not be helpful to the caller. Thus, the call server in connection with the E-911 service will determine the location of the caller and determine which PSAP should receive the call.

Optionally or alternatively, the location of the users on the network may be updated in the call server during the registration and/or discovery process. The location information may also be associated with PSAP location information or PSAP identification information so that the call server may immediately route an emergency call to the appropriate PSAP upon receipt. Once the destination of the emergency call is determined, the call will be connected to the PSAP in a standard fashion.

According to an embodiment of the invention, an in-band location generator 90 is provided, either in the E-911 system or in the call server, to translate location information associated with an access device into location information that may be transmitted to the PSAP operator, and to transmit or make the location information available to the PSAP operator.

The in-band location generator may include a speech synthesis module 92 capable of transforming location information into a speech form so that the operator at the PSAP may be provided with audible location information associated with the location of the calling party. For example, the in-band location generator may be configured to provide civic information such as “this call was made from 111 Oxbow Avenue, 17^{th} floor, room 17c on the east side of the building.” Alternatively, the in-band location generator may be configured to provide geophysical information, such as “this call was made from longitude xxx, latitude yyy, altitude zzz.” Using standard GPS coordinates the civic address of the calling party may be determined from this information. Many different types of speech generating programs may be used to generate audible data and the invention is not limited to a particular type of speech generator. Where the location information is stored in pre-recorded form, the speech synthesis module may be modified or replaced with appropriate circuitry or logic to enable the pre-recorded information to be conveyed to the PSAP operator.

Including the location information in the voice stream (in-band) is advantageous in that it allows data networks to provide location information to PSAP operators without requiring retrofitting of the PSAPs. Specifically, the operator may be provided with location information in audible form before, during, or after the call has been completed, without requiring the deployment of additional equipment at the PSAP.

The location information may be provided initially as the call is being established, for example by playing the location information to the PSAP operator before connecting the caller to the PSAP. This has the advantage of enabling the PSAP operator to more quickly dispatch emergency personnel to the site from which the caller has placed the call. Alternatively, the location information may be played during the emergency communication session, for example by causing the operator to depress one or a sequence of keys to instruct the call server or E-911 system to insert the location information into the voice stream to the operator. The keys in this embodiment may generate Dual-Tone MultiFrequency (DTMF) signals capable of being received and interpreted by the call server or E-911 system, e.g., via the DTMF module 74. The invention is not limited to the use of a DTMF module, however, as other forms of interactive response systems may be used as well.

Optionally, the location information may be generated and issued to both the operator and the person making the emergency call. Playing the location information to both parties enables the caller to confirm or modify the location information during the telephone call with the emergency operator. For example, the PSAP operator may tell the caller that the caller's location information is going to be heard. The caller can listen to the location information and then confirm to the PSAP operator that this is indeed the location. Optionally, for example where the person is on a mobile access device, the person may clarify the location with additional verbal information to make it easier for emergency personnel to find the location.

Optionally, the PSAP operator may be provided with the opportunity to retrieve the location information for a predetermined period of time after the call has ended, so that the call information may be recorded or forwarded to emergency personnel. For example, where an emergency communication session is cut short by the calling person hanging up the phone before the PSAP operator is able to retrieve the location information for the call, the call server or E-911 system may be configured to maintain the connection to enable location information to be audibly played to the PSAP operator. Alternatively, the location information may be stored with the call record so that the information may be later retrieved if necessary by the PSAP operator.

In addition to audible signals, the in-band location generator may include a data module 94 configured to generate textual information or other machine-readable information that may be input into the voice stream and passed in-band to the PSAP operator. For example, the in-band location generator may generate information that is placed into the audio stream and received by a device in the PSAP. Optionally, this information may be made to look like ALI information and formatted in a form customarily used by the ALI database so that the technology deployed in the PSAP is able to receive and understand the information generated by the E-911 system. The invention is not limited in this manner, as other methods of regenerating the location from the information provided by the in-band location generator may be used as well.

FIG. 6 illustrates an embodiment in which the call server and E-911 system are housed on the same computer platform. As shown in FIG. 6, housing the call server and E-911 system on one platform enables duplication of the processors and control logic to be eliminated, as well as simplifies the interconnections in the system. The operation of this system is substantially identical to the system described above in connection with FIG. 5, so a duplicative description will be omitted. The E-911 system may be co-resident with the call server, may be attached to the call server as a blade server, or may be implemented in any number of other configurations. The invention is thus not limited to the embodiments described herein.

Although the invention has been described herein partially in connection with an embodiment in which emergency services are accessed through the generation and receipt of an emergency call, the invention is not limited in this regard as other communication message formats may be used as well. For example, emergency e-mail, emergency text messaging, and other types of emergency communication sessions may be used according to other embodiments of the invention. The invention is thus not limited to emergency telephony with in-band audible location information but rather extends to other message types. Additionally, the invention is not limited to generation of audible location information but may include other in-band signaling of location information to the public emergency operator.

The control logic of FIGS. 5 and 6 may be implemented as a set of program instructions that are stored in computer readable memory within the network element and executed on a microprocessor within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of providing in-band location information in an emergency response network, the method comprising the steps of:
obtaining information relating to an emergency communication session; and
transmitting in-band location information associated with the obtained information over the emergency communication session.

2. The method of claim 1, wherein the emergency call session is between an access device and a Public Safety Answering Point (PSAP).

3. The method of claim 1, further comprising the step of determining a location of the access device.

4. The method of claim 1, wherein the location information is transmitted from the access device to the PSAP.

5. The method of claim 1, wherein the step of transmitting comprises transmitting audible location information associated with the emergency communication session.

6. The method of claim 1, wherein the step of transmitting comprises transmitting machine readable location information associated with the emergency communication session.

7. The method of claim 1, further comprising a step of connecting the emergency communication session from an access device to a Public Safety Answering Point (PSAP), and wherein transmitting in-band location information comprises transmitting location information associated with an access device to the PSAP.

8. The method of claim 1, wherein the emergency communication session is generated on a data network from an access device.

9. The method of claim 8, wherein the access device is an Internet Protocol (IP) access device, and wherein the call is a Voice over IP phone call.

10. A method of providing in-band location information in an emergency response network, the method comprising the steps of:
registering an access device on the data network;
identifying a location of the access device;
generating location information associated with the location of the access device;
associating the location information with the access device; and
making in-band information available on an emergency communication session, wherein the in-band information comprises at least one of the location information and information derived from or associated with the location information.

11. The method of claim 10, wherein the step of making the in-band information available comprises generating audible location information and transmitting the audible location information on the emergency communication session.

12. The method of claim 11, wherein the in-band information is geodetic information.

13. The method of claim 11, wherein the in-band information is civic information.

14. The method of claim 11, wherein the in-band information is pre-recorded information relating to the location of the access device on the data network.

15. The method of claim 10, wherein the step of making the in-band information available comprises generating machine readable location information and transmitting the machine readable location information on the emergency communication session.

16. The method of claim 10, wherein the step of making the in-band information available comprises generating location information in response to a request from a third party.

17. The method of claim 10, wherein the step of making the in-band information available comprises generating location information automatically during the emergency communication session.

18. An apparatus for generating location information associated with an emergency communication session placed on a data network, comprising:
an in-band location generator configured to transmit in-band location information associated with a location of an access device participating in the emergency communication session.

19. The apparatus of claim 18, further comprising a location information system configured to collect location information associated with the access devices on the data network.

20. The apparatus of claim 18, wherein the data network is a wireless data network.

21. The apparatus of claim 18, wherein the data network is an Internet Protocol (IP) network, and wherein the emergency communication session is a Voice over IP call.
